(19) United States
(12) Patent Application Publication
(10) Pub. No.: US 2020/0215958 A1
(43) Pub. Date: Jul. 9, 2020

(54) ARTICLE HOLDING APPARATUS WITH RETRACTABLE BELT

(71) Applicant: FORD GLOBAL TECHNOLOGIES, LLC, Dearborn, MI (US)

(72) Inventors: Eduardo Arturo Aguilar Ruelas, Mexico City (MX); Jose Ramon Gachuz Navarro, Cuautitlan Izcalli (MX)

(21) Appl. No.: 16/241,532

(22) Filed: Jan. 7, 2019

(51) Int. Cl. B60P 7/08; B60R 7/00

(52) U.S. Cl. CPC B60P 7/0823; B60R 2011/0036; B60R 7/005

(57) ABSTRACT

An apparatus is provided for holding an article. The apparatus includes a guideway, a belt, a first retainer, a second retainer and a biasing element. The first retainer, at a first end of the belt, slides along the guideway. The second retainer, at a second end of the belt, also slides along the guideway. The biasing element maintains tension on the belt to provide a positive gripping force to an article held in the apparatus.

### TECHNICAL FIELD

This document relates generally to an apparatus adapted for holding an article and, more particularly, to such an apparatus adapted for use in a motor vehicle.

### BACKGROUND

When articles are transported in a motor vehicle, they are subjected to various acceleration, cornering and braking forces that tend to displace those articles. Shifting articles in a motor vehicle can be annoying and may distract the motor vehicle operator. Accordingly, they should be avoided if possible.

This document relates to a new and improved apparatus adapted for holding an article in a fixed position. Advantageously, the apparatus is inexpensive to manufacture, easily adapted to various convenient locations in the motor vehicle, very easy to use and, by means of a retracting belt, provides a positive gripping force to hold an article securely in position against the various forces generated when accelerating, turning or stopping the motor vehicle.

### SUMMARY

In accordance with the purposes and benefits described herein, a new and improved apparatus is provided for holding an article. That apparatus comprises a guideway, a belt, a first retainer at a first end of the belt, a second retainer at a second end of the belt and a biasing element maintaining tension on the belt. Both the first retainer and the second retainer slide along the guideway.

The guideway may include a first set of opposed guide tracks. The first retainer may engage the first set of opposed guide tracks. The guideway may include a second set of opposed guide tracks. The second retainer may engage the second set of opposed guide tracks.

A first roller may be provided adjacent a first end of the guideway. A second roller may be provided adjacent a second end of the guideway. The belt may extend over the first roller and the second roller.

The biasing element may include a first tension spring having a first end connected to the first retainer and biasing the first retainer toward the first end of the guideway. Further, the biasing element may include a second tension spring having a second end connected to the second retainer and biasing the second retainer toward the second end of the guideway.

The belt may include a gripping surface to hold the article. That gripping surface may be selected from a group consisting of a layer of flexible plastic material, a sleeve of flexible plastic material, a textured material or combinations thereof.

The apparatus may further include a housing. The guideway, the first roller and the second roller may all be carried by the housing. That housing may be adapted for ease of mounting on or within a trim panel of the motor vehicle.

In the following description, there are shown and described several preferred embodiments of the apparatus. As it should be realized, the apparatus is capable of other, different embodiments and its several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and together with the description serve to explain certain principles thereof.

FIG. 1 is an exploded perspective view of one possible embodiment of the apparatus.

FIG. 2A is a front elevational view of the assembled apparatus showing the belt of the apparatus in a fully retracted or home position.

FIG. 2B is a rear perspective view of the apparatus illustrated in FIG. 2A showing the belt of the apparatus in a fully retracted or home position.

FIG. 3A is a view similar to FIG. 2A but illustrating the apparatus with the belt in an extended position.

FIG. 3B is a view similar to FIG. 2B but illustrating the belt in an extended position.

FIG. 4 is a schematic cross sectional view of the apparatus illustrating the first and second retainers that slide along the guideway of the apparatus.

FIG. 5 is a rear view of a motor vehicle illustrating the apparatus mounted to a sidewall trim panel in the storage compartment of the motor vehicle.

FIG. 6 is a perspective view illustrating the apparatus mounted below the second row seat bottom in a motor vehicle.

FIG. 7 is a perspective view of an alternative embodiment wherein the gripping surface comprises a pad of textured material carried on the belt.

Reference will now be made in detail to the present preferred embodiments of the apparatus, examples of which are illustrated in the accompanying drawing figures.

### DETAILED DESCRIPTION

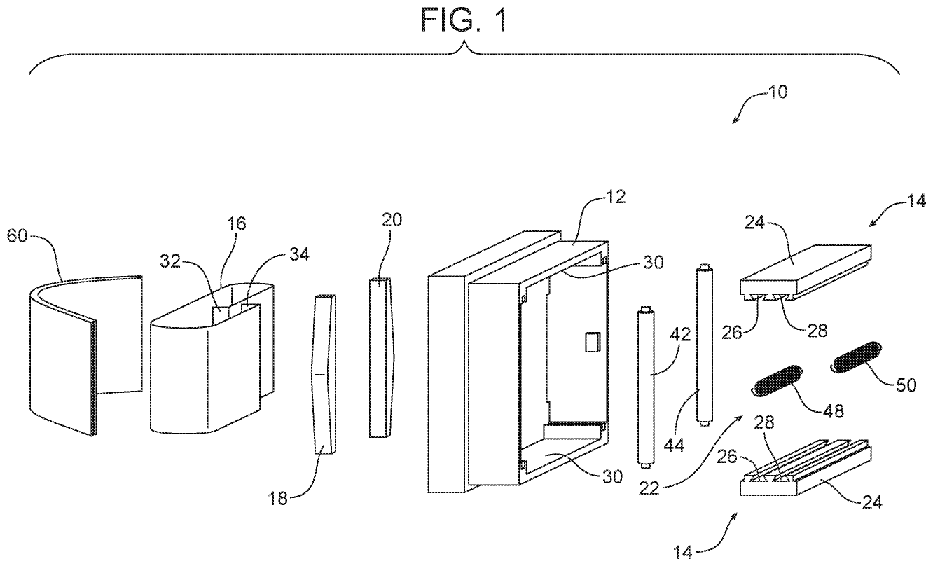

Reference is now made to FIGS. 1, 2A, 2B, 3A, 3B and 4 which illustrate a first embodiment of the new and improved apparatus 10 for holding an article. That apparatus 10 includes a housing 12, a guideway 14, a belt 16, a first belt retainer 18, a second belt retainer 20 and a biasing element 22.

In the illustrated embodiment, the guideway 14 comprises two rail sections 24 that provide a first set of opposed guide tracks 26 and a second set of opposed guide tracks 28. As should be appreciated, the rail sections 24 are held and carried in cooperating receivers 30 of the housing 12. The first retainer 18 is provided at and engages a first end 32 of the belt 16. The second retainer 20 is provided at and engages a second end of the belt 34.

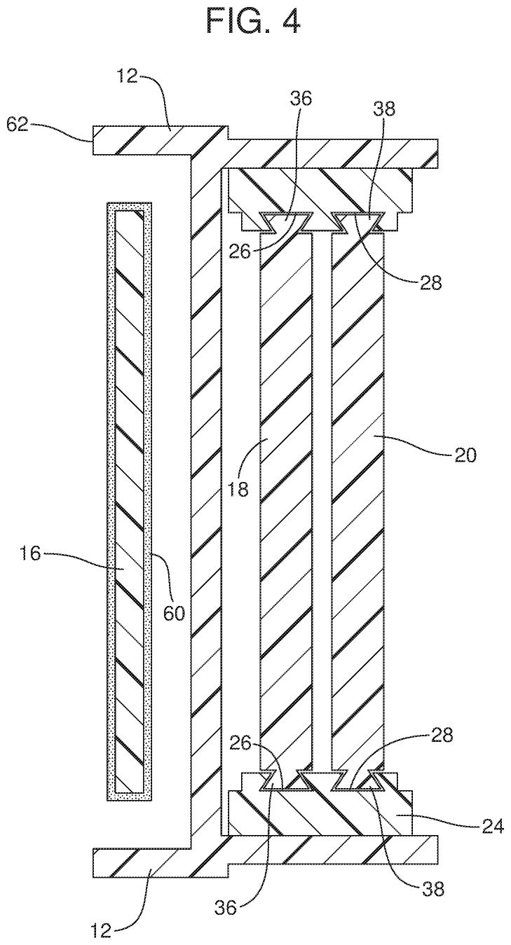

In addition, the first retainer 18 engages in and slides along the first set of opposed guide tracks 26 of the guideway 14. Similarly, the second retainer 20 engages in and slides along the second set of opposed guide tracks 28 of the guideway 14. More particularly, as best illustrated in FIG. 4, the first and second set of opposed guide tracks 26, 28 in the rail sections 24 comprise dovetail-shaped channels. The first retainer 18 includes cooperating dovetail-shaped projections 36 received and held in the first set of opposed guide tracks. Similarly, the second retainer 20 includes dovetailed-shaped projections 38 received and held in the second set of opposed guide tracks 28. Sufficient clearance is provided between the dovetailed-shaped projections 36 and the first set of opposed guide tracks 26 and the second set of dovetailed-shaped projections 38 and the second set of opposed guide tracks 28 to allow for free sliding movement of the first and second retainers 18, 20 along the guideway 14.

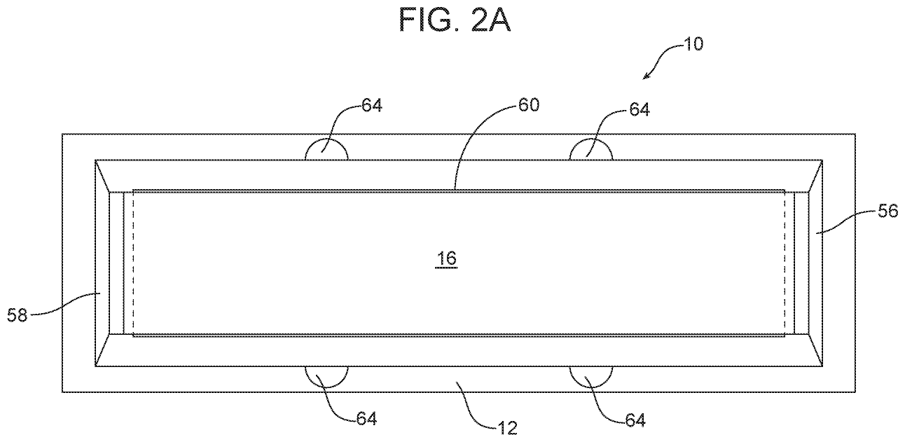

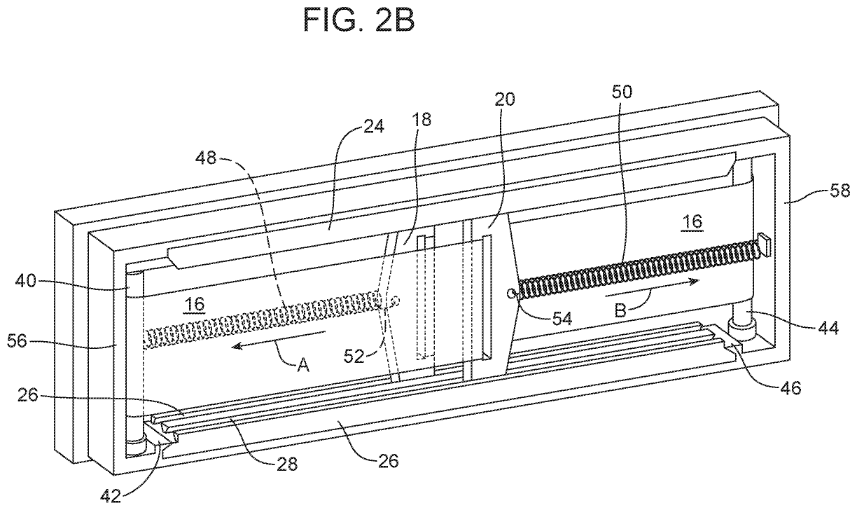

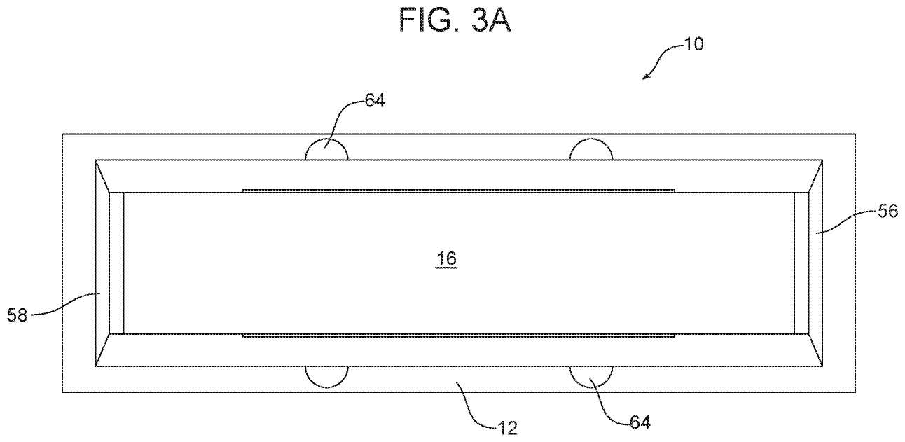

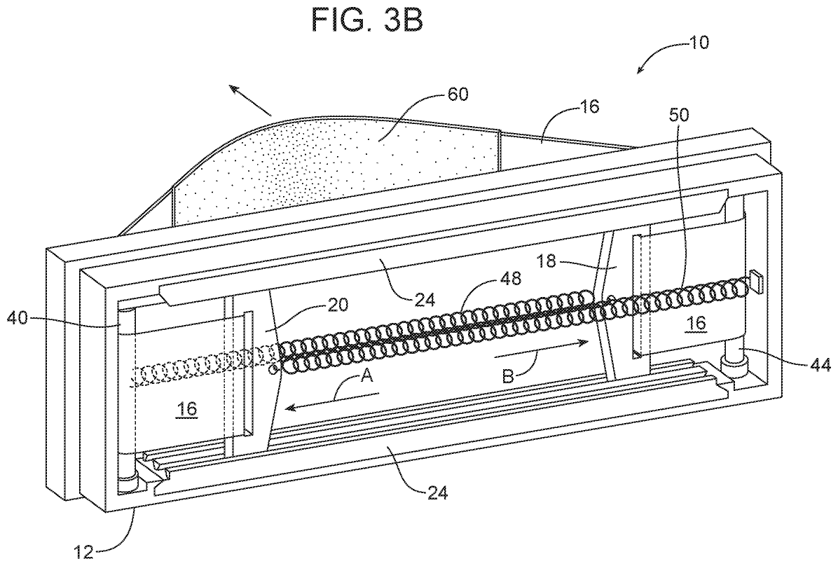

Referring to FIGS. 1, 2B and 3B, the apparatus 10 also includes a first roller 40 carried by the housing 12 adjacent a first end 42 of the guideway and a second roller 44 carried by the housing 12 adjacent a second end 46 of the guideway. As illustrated in FIGS. 2A, 2B, 3A and 3B, the belt 16 extends over the first and second rollers 40, 44 which rotate with respect to the housing 12 and thereby function as pulleys as the belt is displaced from the fully retracted or home position illustrated in FIGS. 2A and 2B to the extended position illustrated in FIGS. 3A and 3B and back again in a manner that will be described in additional detail below.

In the illustrated embodiment, the biasing element 22 comprises a first tension spring 48 and a second tension spring 50. The first tension spring 48 has a first end 52 connected to the first retainer 18 and functions to bias the first retainer toward the first end 42 of the guideway 14. The second retention spring 50 has a second end 54 connected to the second retainer 20 and functions to bias the second retainer toward the second end 46 of the guideway 14. The opposite ends of the two retention springs 48, 50 are secured to the respective opposed sidewalls 56, 58 of the housing 12 (only the opposite end of the spring 50 is visible in the drawing figures). The action arrows A and B in FIGS. 2B and 3B illustrate the direction of the biasing force of the respective first tension spring 48 and second tension spring 50.

As further illustrated in FIGS. 1 and 4, the belt 16 also includes a gripping surface 60 to grip and hold an article. In the embodiment illustrated in FIGS. 1-4, the gripping surface 60 is a sleeve received over the belt 16.

As further illustrated in FIGS. 2A, 3A and 3B, the belt 16 also includes a gripping surface 60 to grip and hold an article. In the embodiment illustrated in FIG. 3B, the gripping surface 60 is a layer behind the belt 16.

As should be appreciated, the biasing element 22 functions to tension the belt 16. Thus, when the belt 16 is in the rest or home position, the biasing element 22 fully retracts the belt 16 into the housing 12 so that the belt 16 is received within the recess of the housing defined by the face 62 thereof. Sufficient space is maintained between the belt 16 and the housing 12 to allow one to engage and pull the belt outwardly into a deployed position as illustrated in FIGS. 3A and 3B. Alternatively, notches 64 (shown in FIGS. 2A and 3A) may be provided in the face 62 of the housing 12 to allow one to more easily grasp the belt 16 and pull the belt 16 into an extended position allowing an article to be inserted between the belt 16 and the housing 12. When one releases the belt 16, the first and second tension springs 48, 50 of the biasing element 22 function to bias the first retainer 18 toward the first end 42 of the guideway 14 and the second retainer 20 toward the second end 46 of the guideway thereby drawing the belt tight against the article which is effectively captured between the belt 16 and, more particularly, the gripping surface 60 thereof and the housing 12.

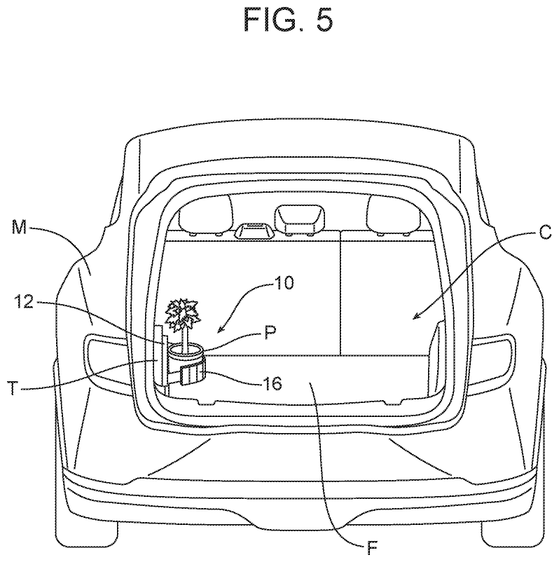

FIG. 5 illustrates the apparatus 10 in the cargo area C of the motor vehicle M. More particularly, the apparatus 10 is mounted to a sidewall trim panel T adjacent the floor F of the cargo area. A potted plant P is illustrated as the article held between the housing 12 and the retracting belt 16.

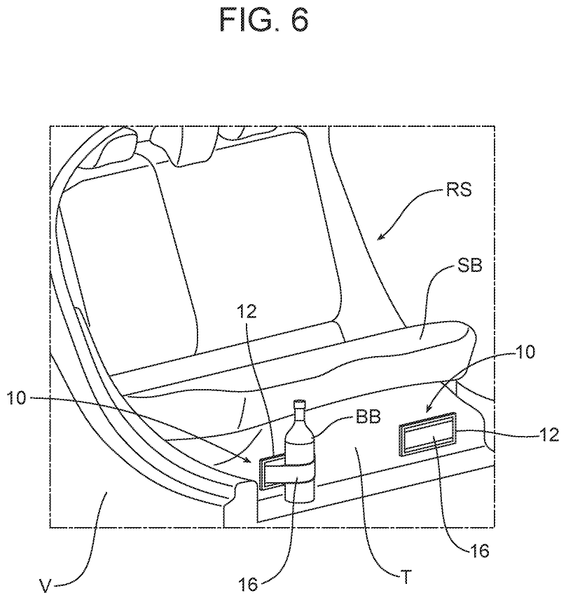

FIG. 6 illustrates two of the apparatus 10 mounted in a motor vehicle V on a trim panel T immediately below the seat bottom SB of the rear seat RS. The apparatus 10 is holding a beverage bottle BB captured between the housing 12 and the retractable belt 16. The apparatus 10 on the right in the drawing figure illustrates the belt 16 in the resting or home position fully retracted within the housing 12.

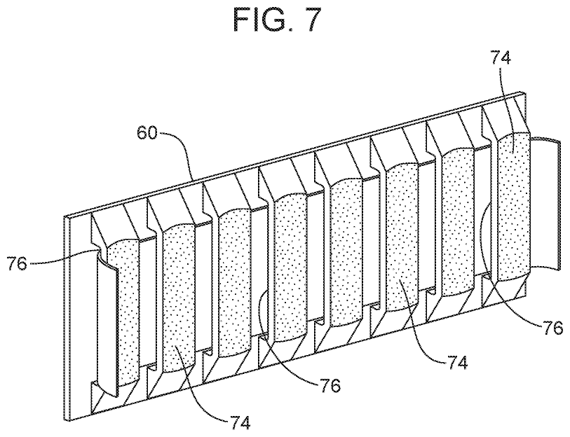

In the alternative embodiment illustrated in FIG. 7, the gripping surface 60 comprises a continuous flexible surface including a plurality of gripping ribs 74. Each gripping rib 74 includes a channel 76. The gripping surface 60 provided by the ribs 74 is connected to the belt 16 by passing the belt through the channels 76.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus for holding an article, comprising:
a guideway;
a belt;
a first retainer at a first end of said belt, said first retainer sliding along said guideway;
a second retainer at a second end of said belt, said second retainer sliding along said guideway; and
a biasing element maintaining tension on said belt.

2. The apparatus of claim 1 wherein said guideway includes a first set of opposed guide tracks.

3. The apparatus of claim 2, wherein said first retainer engages said first set of opposed guide tracks.

4. The apparatus of claim 3, wherein said guideway includes a second set of opposed guide tracks.

5. The apparatus of claim 4, wherein said second retainer engages said second set of opposed guide tracks.

6. The apparatus of claim 5, further including a first roller adjacent a first end of said guideway, said belt extending over said first roller.

7. The apparatus of claim 6, further including a second roller adjacent a second end of said guideway, said belt extending over said second roller.

8. The apparatus of claim 7, wherein said biasing element includes a first tension spring connected to said first retainer and biasing said first retainer toward said first end of said guideway.

9. The apparatus of claim 8, wherein said biasing element includes a second retention spring connected to said second retainer and biasing said second retainer toward said second end of said guideway.

10. The apparatus of claim 9, wherein said belt includes a gripping surface to hold the article.

11. The apparatus of claim 10, wherein said gripping surface is selected from a group consisting of a layer of flexible plastic material, a sleeve of flexible plastic material, a textured material or combinations thereof.

12. The apparatus of claim 11, further including a housing wherein said guideway, said first roller and said second roller are carried by said housing.

13. The apparatus of claim 1, further including a first roller adjacent a first end of said guideway, said belt extending over said first roller.

14. The apparatus of claim 13, further including a second roller adjacent a second end of said guideway, said belt extending over said second roller.

15. The apparatus of claim 14, wherein said biasing element includes a first tension spring connected to said first retainer and biasing said first retainer toward said first end of said guideway.

16. The apparatus of claim 15, wherein said biasing element includes a second retention spring connected to said second retainer and biasing said second retainer toward said second end of said guideway.

17. The apparatus of claim 1, wherein said belt includes a gripping surface to hold the article.

18. The apparatus of claim 17, wherein said gripping surface is selected from a group consisting of a layer of flexible plastic material, a sleeve of flexible plastic material, a textured material or combinations thereof.

19. The apparatus of claim 7, further including a housing wherein said guideway, said first roller and said second roller are carried by said housing.
